(19) United States
(12) Patent Application Publication
(10) Pub. No.: US 2025/0365725 A1
(43) Pub. Date: Nov. 27, 2025

(54) EFFICIENT UPLINK CHANNELS AND PROCEDURES IN SUBBAND-FULLDUPLEX NETWORK

(71) Applicant: MediaTek Singapore Pte. Ltd., Singapore (SG)

(72) Inventors: Sumaila Anning MAHAMA, Cambridge (GB); Mohammed S Aleabe AL-IMARI, Cambridge (GB); Jozsef Gabor NEMETH, Cambridge (GB)

(21) Appl. No.: 18/874,659

(22) PCT Filed: Jul. 19, 2023
(86) PCT No.: PCT/CN2023/108099

§ 371 Date: Dec. 13, 2024

Related U.S. Application Data
(60) Provisional application No. 63/371,238, filed on Aug. 12, 2022.

(51) Int. Cl. H04W 72/1268; H04L 5/00

(52) U.S. Cl. CPC H04W 72/1268; H04L 5/0048

(57) ABSTRACT

Techniques pertaining to efficient uplink (UL) channels and procedures in subband-fullduplex (SBFD) networks are described. A user equipment (UE) applies either of two frequency-domain resource allocations (FDRAs) to a set of slots among a plurality of slots based on a slot type of the set of slots. The UE then performs a uplink (UL) transmission using the set of slots in an SBFD network.

### CROSS REFERENCE TO RELATED PATENT APPLICATION(S)

The present disclosure is part of a non-provisional application claiming the priority benefit of U.S. Patent Application No. 63/371,238, filed 12 Aug. 2022, the content of which herein being incorporated by reference in its entirety.

### TECHNICAL FIELD

The present disclosure is generally related to mobile communications and, more particularly, to efficient uplink (UL) channels and procedures in subband-fullduplex (SBFD) networks.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), current specifications can be applied for frequency-domain resource allocation (FDRA) in dynamic grant (DG) physical uplink shared channel (PUSCH) transmissions in an SBFD network. The base station (e.g., gNB) has the flexibility to dynamically allocate resources in both UL-only slots and SBFD partitioned slots (e.g., slots with UL subband in the middle of two downlink (DL) subbands). There is no issue when using FDRA Type 1, as contiguous resource blocks (RBs) can be allocated in both UL-only slots and SBFD partitioned slots. However, there may be potential issue(s) when using FDRA Type 0. For example, there may be potential overlapping of UL and DL resource block groups (RBGs) near UL/DL subband edge(s) in SBFD partitioned slot(s).

Moreover, current 3GPP specifications cannot be directly applied for FDRA in configured grant (CG) PUSCH transmissions for SBFD. A first issue is that a single FDRA is configured by a higher-layer parameter for all UL slots in Type 1 CG PUSCH transmissions; but this is not efficient for an SBFD system, which has two slot types. A second issue is that a single FDRA is configured by layer-1 signaling for all UL slots in Type-2 CG PUSCH transmissions; but this is not efficient for an SBFD system, which has two slot types. A third issue is that PUSCH transmission periodicities may result in transmissions from UL-only slot(s) overlapping with DL subbands in an SBFD partitioned slot; but the allocated frequency resources in the UL-only slot(s) may not be available in the SBFD partitioned slot. A fourth issue is that there may be potential overlapping of UL and DL RBGs near UL/DG subband edges when using Type-0 FDRA in SBFD partitioned slot(s). Therefore, there is a need for a solution of efficient UL channels and procedures in SBFD networks.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions involving efficient UL channels and procedures in SBFD networks. It is believed that implementations of various proposed schemes in accordance with the present disclosure may address or otherwise alleviate issues described herein.

In one aspect, a method may involve a user equipment (UE) applying either of two FDRAs to a set of slots among a plurality of slots based on a slot type of the set of slots. The method may also involve the UE performing an UL transmission using the set of slots in an SBFD network.

In another aspect, a method may involve a UE determining a starting RB for a set of slots in resource allocation regarding either of intra-slot frequency hopping and inter-slot frequency hopping. The method may also involve the UE performing an UL transmission in an SBFD network with either the intra-slot frequency hopping or the inter-slot frequency hopping enabled.

In yet another aspect, a method may involve a UE applying an FDRA Type 0 in an SBFD partitioned slot. The method may also involve the UE allocating one or more non-overlapping RBs within an UL RBG responsive to the UL RBG overlapping with a DL RBG within the SBFD partitioned slot. The method may further involve the UE performing an UL transmission using the allocated one or more non-overlapping RBs.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Evolved Packet System (EPS), Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario in which a proposed scheme in accordance with the present disclosure may be implemented.

FIG. 3 is a diagram of an example scenario in which a proposed scheme in accordance with the present disclosure may be implemented.

FIG. 4 is a diagram of an example scenario in which a proposed scheme in accordance with the present disclosure may be implemented.

FIG. 5 is a diagram of an example scenario in which a proposed scheme in accordance with the present disclosure may be implemented.

FIG. 6 is a block diagram of an example communication system in accordance with an implementation of the present disclosure.

FIG. 7 is a flowchart of an example process in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to efficient UL channels and procedures in SBFD networks. According to the present disclosure, a number of possible solutions may be implemented separately or jointly. That is, although these possible solutions may be described below separately, two or more of these possible solutions may be implemented in one combination or another.

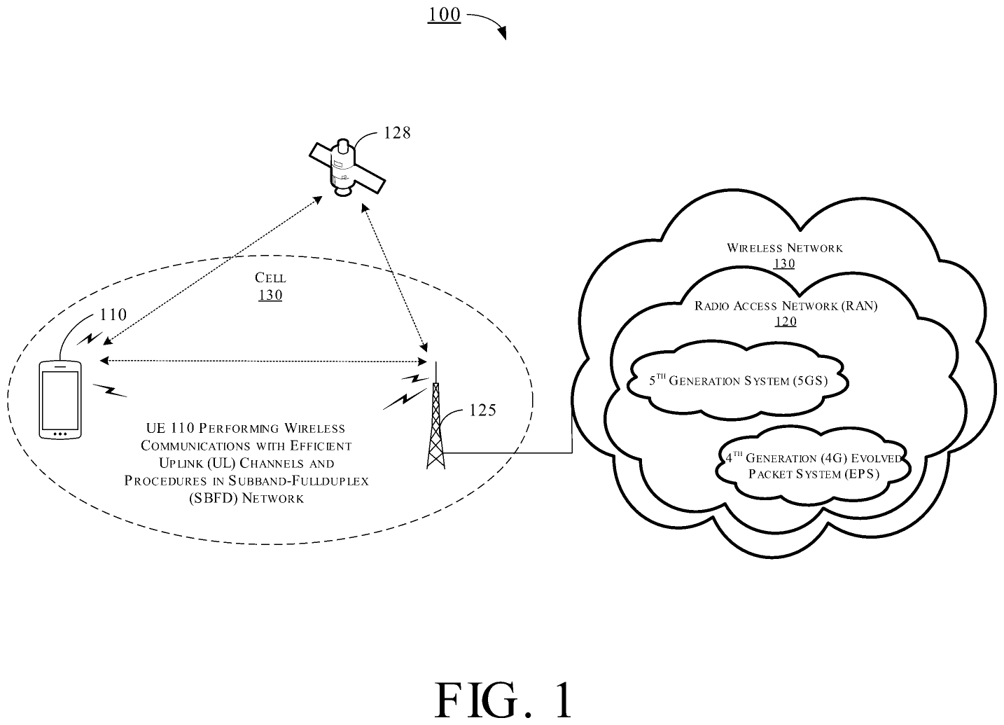

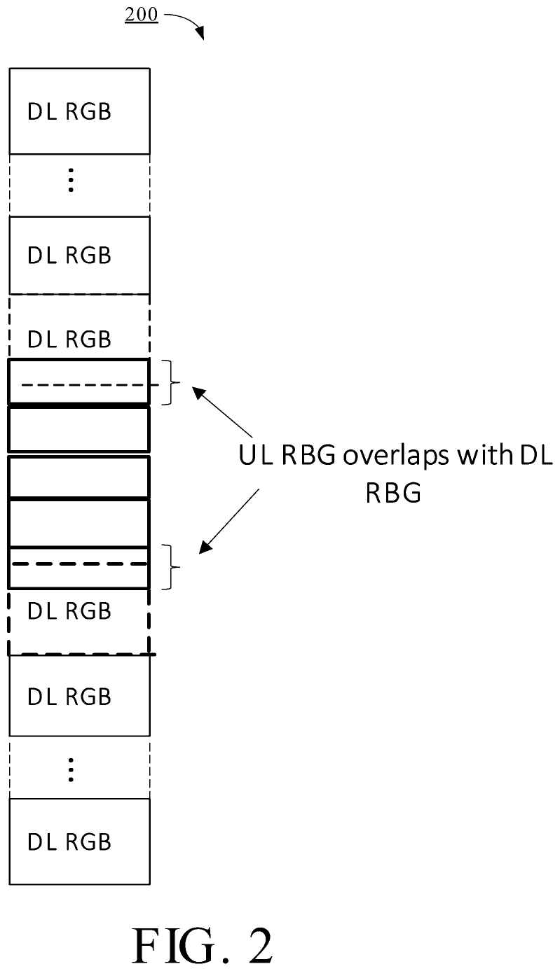

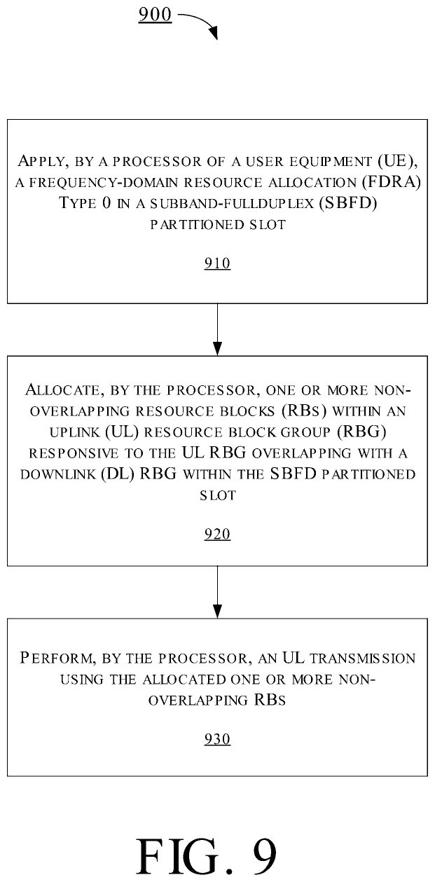

FIG. 1 illustrates an example network environment 100 in which various solutions and schemes in accordance with the present disclosure may be implemented. FIG. 2˜FIG. 9 illustrate examples of implementation of various proposed schemes in network environment 100 in accordance with the present disclosure. The following description of various proposed schemes is provided with reference to FIG. 1˜FIG. 9.

Referring to FIG. 1, network environment 100 may involve a UE 110 in wireless communication with a radio access network (RAN) 120 (e.g., a 5G NR mobile network or another type of network such as an NTN). UE 110 may be in wireless communication with RAN 120 via a base station or terrestrial network node 125 (e.g., an eNB, gNB or transmit-receive point (TRP)) and/or via a satellite or non-terrestrial network node 128. RAN 120 may be a part of a network 130. In network environment 100, UE 110 and network 130 (via terrestrial network node 125 or non-terrestrial network node 128 of RAN 120) may implement various schemes pertaining to efficient UL channels and procedures in SBFD networks, as described below. It is noteworthy that, although various proposed schemes, options and approaches may be described individually below, in actual applications these proposed schemes, options and approaches may be implemented separately or jointly. That is, in some cases, each of one or more of the proposed schemes, options and approaches may be implemented individually or separately. In other cases, some or all of the proposed schemes, options and approaches may be implemented jointly.

FIG. 2 illustrates an example scenario 200 in which a proposed scheme in accordance with the present disclosure may be implemented. Scenario 200 may pertain to RBG allocation at subband edge(s) of FDRA Type 0 for both DG PUSCH and CG PUSCH. In wireless communications based on current 3GPP specifications, there may be potential overlapping of UL and DL RBGs near UL/DL subband edges when using FDRA Type-0 in SBFD partitioned slots, as shown in FIG. 2. Under the proposed scheme, for UL RBG that overlaps with a DL subband when using FDRA Type 0, the non-overlapping RBs within the UL RBG may be allocated for UL transmissions. For instance, RBGs at an edge of UL subband may have a smaller number of RBs per RBG compared to other RBGs. Moreover, under the proposed scheme, the UL subband in an SBFD partitioned slot may be configured as an integer multiple of an RBG size from the perspective of common resource block (CRB) numbering.

In wireless transmissions according to current 3GPP specifications, a single FDRA is defined for CG PUSCH transmissions which is applied over all slots within the defined periodicity. However, the single FDRA may not be efficient for SBFD, which has two types of slots. The two slot types in SBFD (namely, UL-only slot and SBFD partitioned slot) have different bandwidths. Accordingly, it may be beneficial to define a separate FDRA for each of the two slot types to provide flexibility in resource allocation based on resource availability on each slot type.

Under a proposed scheme in accordance with the present disclosure, two FDRAs may be defined for CG PUSCH transmissions in SBFD based on slot type. For instance, the two FDRAs may be provided per CG PUSCH configuration. Alternatively, or additionally, each FDRA may be applied to specific sets of slots. Alternatively, or additionally, the two FDRAs may be provided for Type-1 CG PUSCH transmissions using higher-layer parameters. Alternatively, or additionally, frequencyDomainAllocation within rrc-ConfiguredUplinkGrant inside configuredGrantConfig parameter structure may define the first FDRA. Alternatively, or additionally, an additional parameter, frequencyDomainAllocation2, may be provided within rrc-ConfiguredUplinkGrant to define the second FDRA. Alternatively, or additionally, the two FDRAs may be provided for Type 2 CG PUSCH transmissions using layer-1 signaling. In some implementations, a Frequency Domain Resource Assignment field within the activation downlink control information (DCI) may define the first FDRA. Alternatively, or additionally, an additional field Frequency Domain Resource Assignment 2 may be provided within the activation DCI to define the second FDRA.

In some implementations, the sets of slots where each FDRA is applied may be indicated to the UE by a higher-layer parameter. In some implementations, a bitmap may be used to indicate the sets of slots where each FDRA is applied. In some implementations, sets of slots with bit value=0 may represent full UL slots, and UE 110 may apply one FDRA. Alternatively, or additionally, sets of slots with bit value=1 may represent SBFD slots, and UE 110 may apply the other FDRA. In some implementations, a bitmaps defined by a higher-layer parameter may be used to indicate the sets of slots.

It is noteworthy that PUSCH transmission periodicities may result in transmissions from UL-only slot(s) overlapping with DL subbands in an SBFD partitioned slot. The allocated frequency resources in the UL-only slot(s) may not be available in the SBFD partitioned slot. Thus, it may be beneficial that the two slot types in SBFD have different bandwidths and that periodic transmissions may occur in the same slot type to ensure resource availability for each transmission.

Under a proposed scheme in accordance with the present disclosure, for CG PUSCH transmissions, skipping/disabling/invalidation of CG PUSCH resource allocation may be supported for specific sets of slots. For instance, the sets of slots where skipping/disabling/invalidation is applied may be indicated to UE 110 by a higher-layer parameter. Alternatively, or additionally, CG-PUSCH allocation may resource be skipped/disabled/invalidated for a specific transmission occasion (TO) in case that the configured CG-PUSCH resources overlap, whether partially or fully, with DL subband(s) in the TO. Alternatively, or additionally, a bitmap may be used to indicate the sets of slots where skipping/disabling/invalidation is applied. Alternatively, or additionally, the bitmap may be defined by a higher-layer parameter and may be used to indicate the sets of slots. It is noteworthy that the various features of the proposed scheme as described above may be applied to other UL configured transmissions such as, for example and without limitation, physical uplink control channel (PUCCH) transmissions, sounding reference signal (SRS) transmissions, and scheduling request (SR) transmissions.

With respect to DG PUSCH transmissions with repetitions, a UE can be configured to transmit two or more repetitions that can be in one slot or multiple slots (Type-B) or across multiple consecutive slots (Type-A). For PUSCH repetition Type-A, each slot contains a single repetition, and the resource allocation is the same for all slots. For PUSCH repetition Type-B, the resource allocation is repeated back-to-back in one slot or multiple slots. However, one issue is that PUSCH repetition uses the same resource allocation in multiple consecutive slots, which can be a combination of UL-only slots and SBFD partitioned slots. Slots within a repetition may consists of SBFD and UL-only slots, and different FDRA may be required for each slot type within a repetition. Moreover, PUSCH repetition levels may result in transmissions being repeated across different slot types. In case that the starting slot is UL-only, the allocated frequency resources may overlap with a DL subband in SBFD partitioned slots. Thus, it would be beneficial for slots for PUSCH repetition to include UL-only slots and SBFD partitioned slots, with different bandwidths. Moreover, it would be beneficial to have a separate FDRA defined for each slot type within a repetition to provide flexibility in resource allocation. Furthermore, it would be beneficial for repetition to occur in the same slot type for PUSCH repetition, so as to ensure resource availability for each repetition.

Under a proposed scheme in accordance with the present disclosure, two FDRAs may be defined for a DG PUSCH repetition based on slot types. For instance, each FDRA may be applied to specific sets of slots within the DG PUSCH repetition. Alternatively, or additionally, the sets of slots where each FDRA is applied may be indicated to UE 110 by a higher-layer parameter. Alternatively, or additionally, the sets of slots where each FDRA is applied may be indicated to UE 110 by layer-1 signaling. Alternatively, or additionally, a bitmap may be used to indicate the sets of slots where each FDRA is applied. For instance, for sets of slots with bit value=0, UE 110 may apply one FDRA; and for sets of slots with bit value=1, UE 110 may apply the other FDRA.

Under the proposed scheme, for a DG PUSCH repetition, skipping of repetition may be supported for specific sets of slots. For instance, skipping may be applied in case that PUSCH repetition overlaps with DL subbands in SBFD slots. Alternatively, or additionally, the sets of slots where skipping is applied may be indicated to UE 110 may a higher-layer parameter. Alternatively, or additionally, the sets of slots where skipping is applied may be indicated to UE 110 by a layer-1 signaling. In some implementations, in case that PUSCH repetition occurs on a slot indicated for skipping, UE 110 may postpone the repetition. Alternatively, or additionally, in case that PUSCH repetition occurs on a slot indicated for skipping, UE 110 may drop the repetition. In some implementations, a bitmap may be used to indicate the sets of slots where skipping is applied. Alternatively, or additionally, the bitmap may be defined by a higher-layer parameter and may be used to indicate the sets of slots. Alternatively, or additionally, the bitmap may be defined by a layer-1 signaling and may be used to indicate the sets of slots. It is noteworthy that the various features of the proposed scheme as described above may be applied to other UL repetition schemes including, for example and without limitation, CG-PUSCH repetitions and PUCCH repetitions.

With respect to frequency hopping, a UE can be instructed to apply either intra-slot or inter-slot frequency hopping. The number of RB offsets between two frequency hops depends on the size of allocated bandwidth part (BWP). For a BWP smaller than 50 physical resource blocks (PRBs), one of two RB offsets is indicated to the UE. For a larger BWP, one of four RB offsets is indicated to the UE.

For intra-slot frequency hopping, a time-domain resource is divided into two sections. The first section applies the original FDRA assignment with no frequency offset, and the second section applies an RB offset based on frequencyHoppingOffsetList within PUSCH-Config. However, there is an issue that, in SBFD partitioned slots, the resource allocation with frequency hopping is likely to overlap with DL subbands since the RB start, in the current 3GPP specification, is confined within the BWP of the UL-only slot.

For inter-slot frequency hopping, there can be different RB assignments for even and odd numbered slots. Even numbered slots apply the original FDRA assignment with no frequency hopping, and odd numbered slots apply an RB offset based on frequencyHoppingOffsetList within PUSCH-Config. However, there is an issue that, in SBFD partitioned slots/symbols, the resource allocation with frequency hopping is likely to overlap with DL subbands since the RB start, in the current 3GPP specification, is confined within the BWP of the UL-only slot. Another issue is that, for enhancement with separate FDRA for each slot type, frequency hopping across slots with different FDRAs may not be efficient.

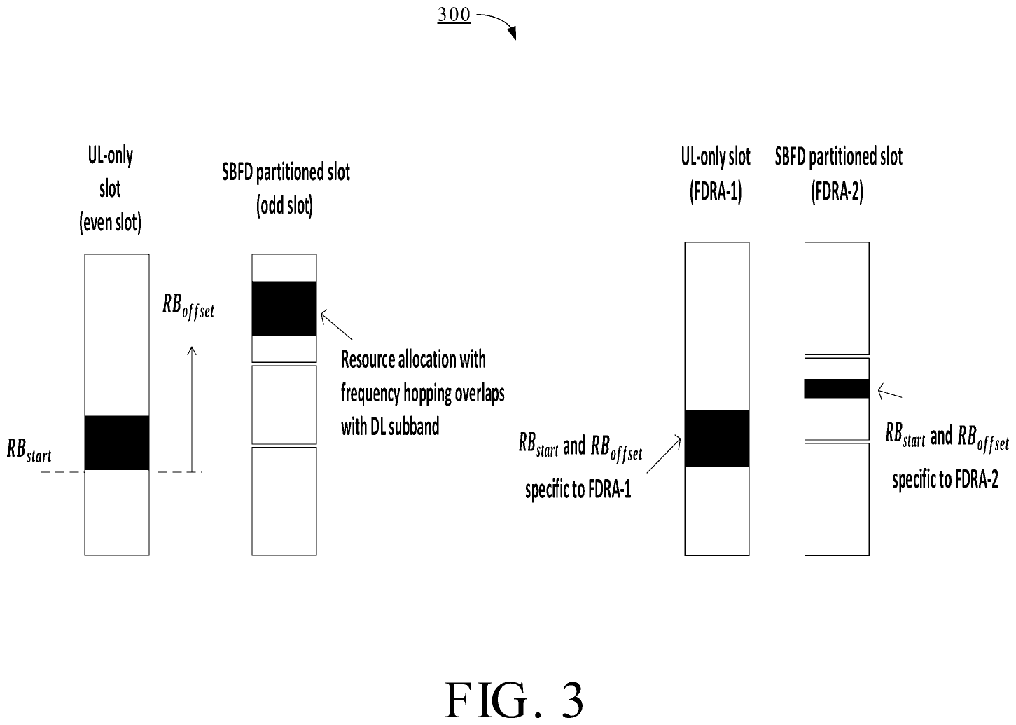

FIG. 3 illustrates an example scenario 300 of frequency hopping in SBFD. With respect to frequency hopping in SBFD, for both intra-slot and inter-slot frequency, the RB start after applying frequency hopping offset is calculated such that the resource allocation is confined within the UL BWP. For an SBFD partitioned slot, the resource allocation with frequency hopping is likely to overlap with DL subbands since the bandwidth of UL subbands is less than the BWP of UL-only slots. For the proposed enhancement with separate FDRA for each slot type, frequency hopping from UL-only slot (with FDRA-1) to an SBFD partitioned slot (with FDRA-2), and vice versa, may not be efficient due to the different resource allocations of each slot type. Thus, it may be beneficial for the starting RB for intra-slot and inter-slot frequency hopping to be chosen to ensure that the resource allocation always remains within UL subband(s) of an SBFD partitioned slot. It may also be beneficial that, for the case with separate FDRA for each slot type, the inter-slot frequency hopping procedure may consider the FDRA for each slot type to ensure resource availability.

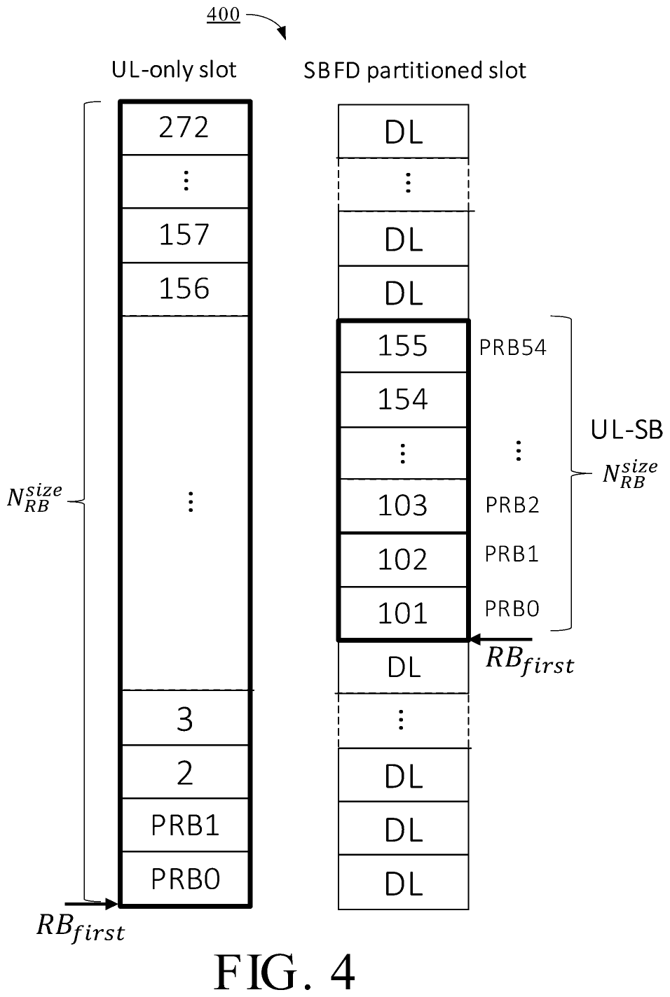

FIG. 4 illustrates an example scenario 400 in which a proposed scheme in accordance with the present disclosure may be implemented. Scenario 400 may pertain to frequency hopping in SBFD. Under the proposed scheme, when intra-slot frequency hopping is enabled for SBFD, the starting RB in each hop may be defined as follows:

$${RB}_{start} = \{ \begin{matrix}{RB}_{start} & i = 0 \\ ( {RB}_{start} + {RB}_{offset} ) mod {N}_{RB}^{size} ( j ) + {RB}_{first} ( j ) & i = 1\end{matrix}$$

Here, RBₛₜₐᵣₜ denotes the starting RB within the slot based on FDRA, RB_{offset} denotes the frequency hopping offset, i=0 and i=1 are the first hop and second hop, respectively,

$${N}_{RB}^{size} ( j )$$

denotes the maximum number of RBs for the set of slots with index j, and RB_{first}(j) denotes the first UL RB for the set of slots with index j, j∈{0,1}.

Under the proposed scheme, the sets of slots may be indicated to UE 110 by a higher-layer parameter. Alternatively, or additionally, the sets of slots may be indicated to UE 110 by a layer-1 signaling. Alternatively, or additionally, a bitmap may be used to indicate the sets of slots. For instance, the bitmap may be defined by a higher-layer parameter and may be used to indicate the sets of slots. Alternatively, or additionally, the bitmap may be defined by a layer-1 signaling and may be used to indicate the sets of slots. In some implementations, the bit value of each bit of the bitmap may serve as a pointer to a table that defines the values of

$${N}_{RB}^{size} ( j )$$

and RB_{first}(j). In some cases, RB_{offset} may be selected from a set of integer values between 1 and

$${N}_{RB}^{size} ( j ) - 1.$$

Moreover, RBₛₜₐᵣₜ may be selected from a set of integer values between 0 and

$${N}_{RB}^{size} ( j ) - 1.$$

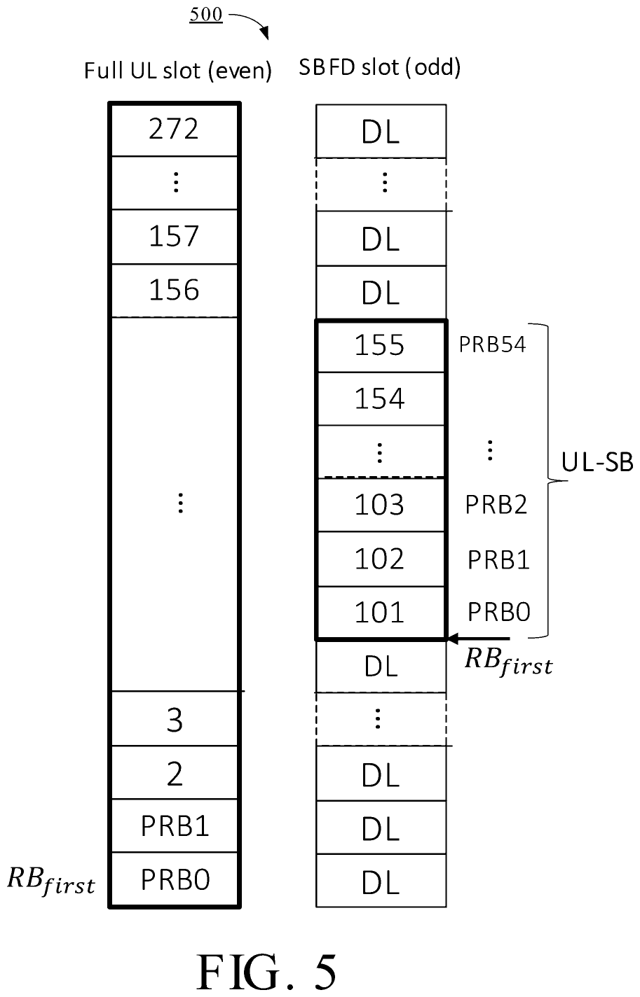

FIG. 5 illustrates an example scenario 500 in which a proposed scheme in accordance with the present disclosure may be implemented. Scenario 500 may pertain to frequency hopping in SBFD. Under the proposed scheme, when inter-slot frequency hopping is enabled for SBFD, the starting RB in each slot may be defined as follows:

$${RB}_{start} ( n ) = \{ \begin{matrix}{RB}_{start} & n mod 2 = 0 \\ ( {RB}_{start} + {RB}_{offset} ) mod {N}_{RB}^{size} ( j ) + {RB}_{first} ( j ) & n mod 2 = 1\end{matrix}$$

Here, n denotes the current slot number within a system radio frame, RBₛₜₐᵣₜ denotes the starting RB within the slot based on FDRA, RB_{offset} denotes the frequency hopping offset,

$${N}_{RB}^{size} ( j )$$

denotes the maximum number of RBs for the set of slots with index j, and RB_{first}(j) denotes the first UL RB for the set of slots with index j, j∈{0,1}.

Under the proposed scheme, the sets of slots may be indicated to UE 110 by a higher-layer parameter. Alternatively, or additionally, the sets of slots may be indicated to UE 110 by a layer-1 signaling. Alternatively, or additionally, a bitmap may be used to indicate the sets of slots. For instance, the bitmap may be defined by a higher-layer parameter and may be used to indicate the sets of slots. Alternatively, or additionally, the bitmap may be defined by a layer-1 signaling and may be used to indicate the sets of slots. In some implementations, the bit value of each bit of the bitmap may serve as a pointer to a table that defines the values of

$${N}_{RB}^{size} ( j )$$

and RB_{first}(j). In some cases, RB_{offset} may be selected from a set of integer values between 1 and

$${N}_{RB}^{size} ( j ) - 1.$$

Moreover, RBₛₜₐᵣₜ may be selected from a set of integer values between 0 and

$${N}_{RB}^{size} ( j ) - 1.$$

Under a proposed scheme in accordance with the present disclosure with respect to frequency hopping in SBFD, for the proposed enhancements with separate FDRA for each slot type, the starting RB for each slot may be defined as follows:

$${RB}_{start} ( n ) = \{ \begin{matrix}{RB}_{start} ( j ) & n mod 2 = 0 \\ ( {RB}_{start} ( j ) + {RB}_{offset} ) mod {N}_{RB}^{size} ( j ) + {RB}_{first} ( j ) & n mod 2 = 1\end{matrix}$$

Here, n denotes the current slot number within a system radio frame, RBₛₜₐᵣₜ(j) denotes the starting RB based on the FDRA for the set of slots with index j, RB_{offset} denotes the frequency offset,

$${N}_{RB}^{size} ( j )$$

denotes the maximum number of RBs for the set of slots with index j, and RB_{first}(j) denotes the first UL RB for the set of slots with index j. j∈{0,1}.

Under the proposed scheme, the sets of slots may be indicated to UE 110 by a higher-layer parameter. Alternatively, or additionally, the sets of slots may be indicated to UE 110 by a layer-1 signaling. Alternatively, or additionally, a bitmap may be used to indicate the sets of slots. For instance, the bitmap may be defined by a higher-layer parameter and may be used to indicate the sets of slots. Alternatively, or additionally, the bitmap may be defined by a layer-1 signaling and may be used to indicate the sets of slots. In some cases, RB_{offset} may be selected from a set of integer values between 1 and

$${N}_{RB}^{size} ( j ) - 1.$$

Moreover, RBₛₜₐᵣₜ may be selected from a set of integer values between 0 and

$${N}_{RB}^{size} ( j ) - 1.$$

Under a proposed scheme in accordance with the present disclosure with respect to frequency hopping in SBFD, when inter-slot frequency hopping is enabled for SBFD, frequency hopping on specific set of slots may be supported. For instance, inter-slot frequency hopping may be enabled on UL-only of slots. Alternatively, or additionally, the frequency hopping may follow the legacy frequency hopping procedure. Alternatively, or additionally, the set of slots where frequency hopping is applied may be indicated to UE 110 by a higher-layer parameter. Alternatively, or additionally, the set of slots where frequency hopping is applied may be indicated to UE 110 by a layer-1 signaling. Alternatively, or additionally, the set of slots where frequency hopping is not applied (skipped) may be indicated to UE 110 by a higher-layer parameter. Alternatively, or additionally, the set of slots where frequency hopping is not applied (skipped) may be indicated to UE 110 by a layer-1 signaling. Alternatively, or additionally, a bitmap may be used to indicate the sets of slots where frequency hopping is applied. Alternatively, or additionally, a bitmap may be used to indicate the sets of slots where frequency hopping is not applied.

### Illustrative Implementations

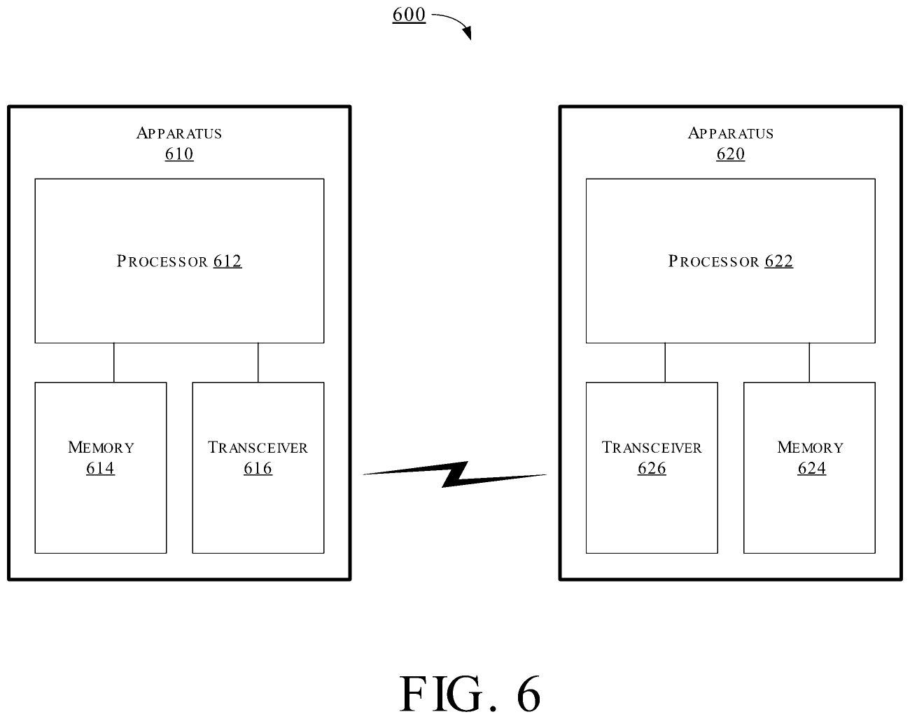

FIG. 6 illustrates an example communication system 600 having at least an example apparatus 610 and an example apparatus 620 in accordance with an implementation of the present disclosure. Each of apparatus 610 and apparatus 620 may perform various functions to implement schemes, techniques, processes and methods described herein pertaining to efficient UL channels and procedures in SBFD networks, including the various schemes described above with respect to various proposed designs, concepts, schemes, systems and methods described above, including network environment 100, as well as processes described below.

Each of apparatus 610 and apparatus 620 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 610 and apparatus 620 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 610 and apparatus 620 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in an eNodeB in an LTE, LTE-Advanced or LTE-Advanced Pro network or in a gNB or TRP in a 5G network, an NR network or an IoT network.

In some implementations, each of apparatus 610 and apparatus 620 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 610 and apparatus 620 may be implemented in or as a network apparatus or a UE. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC or RISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to efficient UL channels and procedures in SBFD networks in accordance with various implementations of the present disclosure.

In some implementations, apparatus 610 may also include a transceiver 616 coupled to processor 612. Transceiver 616 may be capable of wirelessly transmitting and receiving data. In some implementations, transceiver 616 may be capable of wirelessly communicating with different types of wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs/wireless networks of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory.

Each of apparatus 610 and apparatus 620 may be a communication entity capable of communicating with each other using various proposed schemes in accordance with the present disclosure. For illustrative purposes and without limitation, a description of capabilities of apparatus 610, as a UE (e.g., UE 110), and apparatus 620, as a network node (e.g., terrestrial network node 125 or non-terrestrial network node 128) of a network (e.g., network 130 as a 5G/NR mobile network), is provided below in the context of example processes 700, 800 and 900.

### Illustrative Processes

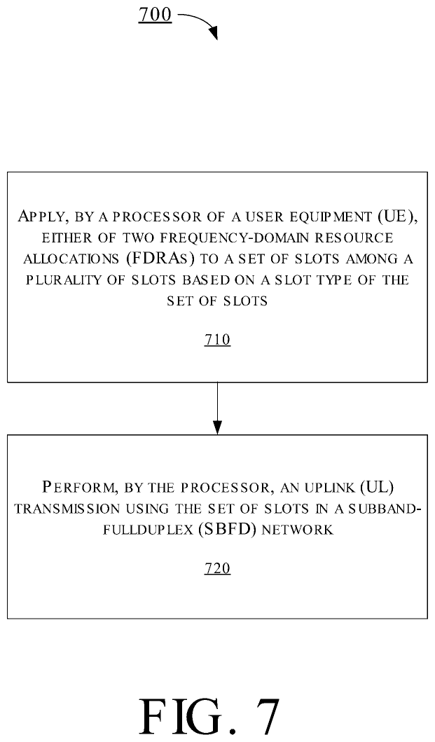

FIG. 7 illustrates an example process 700 in accordance with an implementation of the present disclosure. Process 700 may represent an aspect of implementing various proposed designs, concepts, schemes, systems and methods described above, whether partially or entirely, including those pertaining to those described above. More specifically, process 700 may represent an aspect of the proposed concepts and schemes pertaining to efficient UL channels and procedures in SBFD networks. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 610 and apparatus 620 as well as any variations thereof. Solely for illustrative purposes and without limiting the scope, process 700 is described below in the context of apparatus 610 as a UE (e.g., UE 110) and apparatus 620 as a communication entity such as a network node or base station (e.g., terrestrial network node 125 or non-terrestrial network node 128) of a network (e.g., network 130 as a 5G/NR mobile network). Process 700 may begin at block 710.

At 710, process 700 may involve processor 612 of apparatus 610 applying either of two FDRAs to a set of slots among a plurality of slots based on a slot type of the set of slots. Process 700 may proceed from 710 to 720.

At 720, process 700 may involve processor 612 performing, via transceiver 616, an UL transmission using the set of slots in an SBFD network.

In some implementations, in applying either of the two FDRAs to the set of slots, process 700 may involve processor 612 applying a first FDRA of the two FDRAs responsive to each slot of the set of slots being a UL-only slot. Alternatively, process 700 may involve processor 612 applying a second FDRA of the two FDRAs responsive to each slot of the set of slots being an SBFD partitioned slot.

In some implementations, the UL transmission may include a CG PUSCH transmission. In such cases, the two FDRAs may be provided for Type-1 CG PUSCH transmission via a higher-layer parameter. Moreover, the two FDRAs may be provided for Type-2 CG PUSCH transmission via a layer-1 signaling.

In some implementations, the UL transmission may include a DG PUSCH transmission. In such cases, the set of slots where either of the two FDRAs is applied may be indicated to apparatus 610 (e.g., from network 130 via apparatus 620) via a higher-layer parameter, a layer-1 signaling or a bitmap.

In some implementations, the set of slots among the plurality of slots where either of the two FDRAs is applied may be indicated to apparatus 610 (e.g., from network 130 via apparatus 620) via a higher-layer parameter or a bitmap.

In some implementations, process 700 may further involve processor 612 skipping, disabling or otherwise invalidating a resource allocation regarding one or more other sets of slots among the plurality of slots. In such cases, an indication of the one or more other sets of slots may be provided to apparatus 610 (e.g., from network 130 via apparatus 620) via a higher-layer parameter or a bitmap.

In some implementations, in skipping the resource allocation, process 700 may involve processor 612 skipping the resource allocation regarding a CG PUSCH transmission, a PUCCH transmission, an SRS transmission, or an SR transmission.

In some implementations, in skipping the resource allocation, process 700 may involve processor 612 skipping a CG PUSCH resource allocation for a specific TO responsive to one or more configured CG-PUSCH resources overlapping with a DL subband in the TO.

In some implementations, process 700 may further involve processor 612 skipping, disabling or otherwise invalidating a repetition regarding one or more other sets of slots among the plurality of slots. In such cases, an indication of the one or more other sets of slots is provided to apparatus 610 (e.g., from network 130 via apparatus 620) via a higher-layer parameter, a layer-1 signaling or a bitmap.

In some implementations, in skipping the repetition, process 700 may involve processor 612 skipping the repetition regarding a DG PUSCH repetition, a CG PUSCH repetition, or a PUCCH repetition.

In some implementations, in skipping the repetition, process 700 may involve processor 612 skipping a DG PUSCH repetition responsive to the DG PUSCH repetition overlapping with a DL subband in an SBFD slot.

In some implementations, in skipping the repetition, process 700 may involve processor 612 postponing or dropping a DG PUSCH repetition responsive to the DG PUSCH repetition occurring on a slot indicated for skipping.

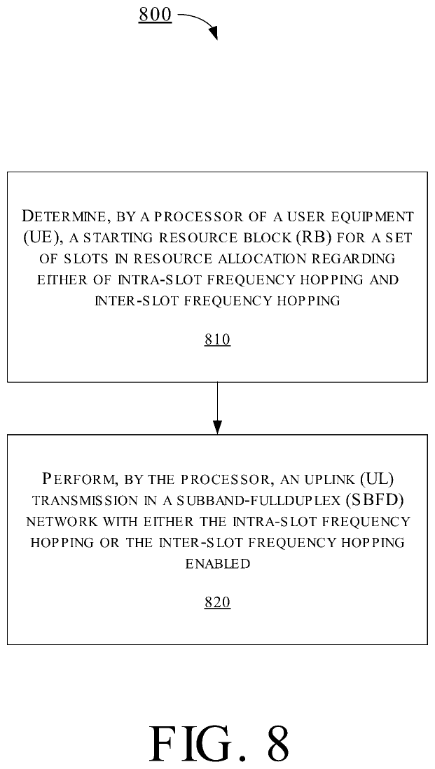

FIG. 8 illustrates an example process 800 in accordance with an implementation of the present disclosure. Process 800 may represent an aspect of implementing various proposed designs, concepts, schemes, systems and methods described above, whether partially or entirely, including those pertaining to those described above. More specifically, process 800 may represent an aspect of the proposed concepts and schemes pertaining to efficient UL channels and procedures in SBFD networks. Process 800 may include one or more operations, actions, or functions as illustrated by one or more of blocks 810 and 820. Although illustrated as discrete blocks, various blocks of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed iteratively. Process 800 may be implemented by or in apparatus 610 and apparatus 620 as well as any variations thereof. Solely for illustrative purposes and without limiting the scope, process 800 is described below in the context of apparatus 610 as a UE (e.g., UE 110) and apparatus 620 as a communication entity such as a network node or base station (e.g., terrestrial network node 125 or non-terrestrial network node 128) of a network (e.g., network 130 as a 5G/NR mobile network). Process 800 may begin at block 810.

At 810, process 800 may involve processor 612 of apparatus 610 determining a starting RB for a set of slots in resource allocation regarding either of intra-slot frequency hopping and inter-slot frequency hopping. Process 800 may proceed from 810 to 820.

At 820, process 800 may involve processor 612 performing, via transceiver 616, an UL transmission in an SBFD network with either the intra-slot frequency hopping or the inter-slot frequency hopping enabled.

In some implementations, responsive to the intra-slot frequency hopping being enabled for SBFD, the starting RB in each hop may be determined as follows:

$${RB}_{start} = \{ \begin{matrix}{RB}_{start} & i = 0 \\ ( {RB}_{start} + {RB}_{offset} ) mod {N}_{RB}^{size} ( j ) + {RB}_{first} ( j ) & i = 1\end{matrix}$$

Here, RBₛₜₐᵣₜ denotes the starting RB within the slot based on FDRA, RB_{offset} denotes the frequency hopping offset, i=0 and i=1 are the first hop and second hop, respectively,

$${N}_{RB}^{size} ( j )$$

denotes the maximum number of RBs for the set of slots with index j, and RB_{first}(j) denotes the first UL RB for the set of slots with index j, j∈{0,1}.

In some implementations, an indication of the set of slots may be provided to apparatus 610 (e.g., from network 130 via apparatus 620) via a higher-layer parameter, a layer-1 signaling or a bitmap.

In some implementations, responsive to the inter-slot frequency hopping being enabled for SBFD, the starting RB in each slot may be determined as follows:

$${RB}_{start} ( n ) = \{ \begin{matrix}{RB}_{start} & n mod 2 = 0 \\ ( {RB}_{start} + {RB}_{offset} ) mod {N}_{RB}^{size} ( j ) + {RB}_{first} ( j ) & n mod 2 = 1\end{matrix}$$

Here, n denotes the current slot number within a system radio frame, RBₛₜₐᵣₜ denotes the starting RB within the slot based on FDRA, RB_{offset} denotes the frequency hopping offset,

$${N}_{RB}^{size} ( j )$$

denotes the maximum number of RBs for the set of slots with index j, and RB_{first}(j) denotes the first UL RB for the set of slots with index j, j∈{0,1}.

In some implementations, an indication of the set of slots may be provided to apparatus 610 (e.g., from network 130 via apparatus 620) via a higher-layer parameter, a layer-1 signaling or a bitmap.

In some implementations, process 800 may further involve processor 612 performing additional operations. For instance, process 800 may involve processor 612 applying an FDRA of two FDRAs responsive to each slot of the set of slots being a UL-only slot. Alternatively, or additionally, process 800 may involve processor 612 applying a second FDRA of the two FDRAs responsive to each slot of the set of slots being an SBFD partitioned slot. In some implementations, the starting RB in each slot may be determined as follows:

$${RB}_{start} ( n ) = \{ \begin{matrix}{RB}_{start} ( j ) & n mod 2 = 0 \\ ( {RB}_{start} ( j ) + {RB}_{offset} ) mod {N}_{RB}^{size} ( j ) + {RB}_{first} ( j ) & n mod 2 = 1\end{matrix}$$

Here, n denotes the current slot number within a system radio frame, RBₛₜₐᵣₜ(j) denotes the starting RB based on the FDRA for the set of slots with index j, RB_{offset} denotes the frequency offset,

$${N}_{RB}^{size} ( j )$$

denotes the maximum number of RBs for the set of slots with index j, and RB_{first}(j) denotes the first UL RB for the set of slots with index j. j∈{0,1}.

In some implementations, an indication of the set of slots may be provided to apparatus 610 (e.g., from network 130 via apparatus 620) via a higher-layer parameter, a layer-1 signaling or a bitmap.

FIG. 9 illustrates an example process 900 in accordance with an implementation of the present disclosure. Process 900 may represent an aspect of implementing various proposed designs, concepts, schemes, systems and methods described above, whether partially or entirely, including those pertaining to those described above. More specifically, process 900 may represent an aspect of the proposed concepts and schemes pertaining to efficient UL channels and procedures in SBFD networks. Process 900 may include one or more operations, actions, or functions as illustrated by one or more of blocks 910, 920 and 930. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. Furthermore, one or more of the blocks/sub-blocks of process 900 may be executed iteratively. Process 900 may be implemented by or in apparatus 610 and apparatus 620 as well as any variations thereof. Solely for illustrative purposes and without limiting the scope, process 900 is described below in the context of apparatus 610 as a UE (e.g., UE 110) and apparatus 620 as a communication entity such as a network node or base station (e.g., terrestrial network node 125 or non-terrestrial network node 128) of a network (e.g., network 130 as a 5G/NR mobile network). Process 900 may begin at block 910.

At 910, process 900 may involve processor 612 of apparatus 610 applying an FDRA Type 0 in an SBFD partitioned slot. Process 900 may proceed from 910 to 920.

At 920, process 900 may involve processor 612 allocating one or more non-overlapping RBs within an UL RBG responsive to the UL RBG overlapping with a DL RBG within the SBFD partitioned slot. Process 900 may proceed from 920 to 930.

At 930, process 900 may involve processor 612 performing, via transceiver 616, an UL transmission using the allocated one or more non-overlapping RBs.

In some implementations, an UL subband in the SBFD partitioned slot may be configured as an integer multiple of a RBG size from a perspective of CRB numbering.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
applying, by a processor of a user equipment (UE), either of two frequency-domain resource allocations (FDRAs) to a set of slots among a plurality of slots based on a slot type of the set of slots; and
performing, by the processor, an uplink (UL) transmission using the set of slots in a subband-fullduplex (SBFD) network.

2. The method of claim 1, wherein the applying either of the two FDRAs to the set of slots comprises:
applying a first FDRA of the two FDRAs responsive to each slot of the set of slots being a UL-only slot; or
applying a second FDRA of the two FDRAs responsive to each slot of the set of slots being an SBFD partitioned slot.

3. The method of claim 1, wherein the UL transmission comprises a configured grant (CG) physical uplink shared channel (PUSCH) transmission, wherein the two FDRAs are provided for Type-1 CG PUSCH transmission via a higher-layer parameter, and wherein the two FDRAs are provided for Type-2 CG PUSCH transmission via a layer-1 signaling.

4. The method of claim 1, wherein the UL transmission comprises a dynamic grant (DG) physical uplink shared channel (PUSCH) transmission, and wherein the set of slots where either of the two FDRAs is applied is indicated to the UE via a higher-layer parameter, a layer-1 signaling or a bitmap.

5. The method of claim 1, wherein the set of slots among the plurality of slots where either of the two FDRAs is applied is indicated to the UE via a higher-layer parameter or a bitmap.

6. The method of claim 1, further comprising:
skipping, by the processor, a resource allocation regarding one or more other sets of slots among the plurality of slots,
wherein an indication of the one or more other sets of slots is provided to the UE via a higher-layer parameter or a bitmap.

7. The method of claim 6, wherein the skipping of the resource allocation comprises skipping the resource allocation regarding a configured grant (CG) physical uplink shared channel (PUSCH) transmission, a physical uplink control channel (PUCCH) transmission, a sounding reference signal (SRS) transmission, or a scheduling request (SR) transmission.

8. The method of claim 6, wherein the skipping of the resource allocation comprises skipping a configured grant (CG) physical uplink shared channel (PUSCH) resource allocation for a specific transmission occasion (TO) responsive to one or more configured CG-PUSCH resources overlapping with a downlink (DL) subband in the TO.

9. The method of claim 1, further comprising:
skipping, by the processor, a repetition regarding one or more other sets of slots among the plurality of slots,
wherein an indication of the one or more other sets of slots is provided to the UE via a higher-layer parameter, a layer-1 signaling or a bitmap.

10. The method of claim 9, wherein the skipping of the repetition comprises skipping the repetition regarding a dynamic grant (DG) physical uplink shared channel (PUSCH) repetition, a configured grant (CG) physical uplink shared channel (PUSCH) repetition, or a physical uplink control channel (PUCCH) repetition.

11. The method of claim 9, wherein the skipping of the repetition comprises skipping a dynamic grant (DG) physical uplink shared channel (PUSCH) repetition responsive to the DG PUSCH repetition overlapping with a downlink (DL) subband in an SBFD slot.

12. The method of claim 9, wherein the skipping of the repetition comprises postponing or dropping a dynamic grant (DG) physical uplink shared channel (PUSCH) repetition responsive to the DG PUSCH repetition occurring on a slot indicated for skipping.

13. A method, comprising:
determining, by a processor of a user equipment (UE), a starting resource block (RB) for a set of slots in resource allocation regarding either of intra-slot frequency hopping and inter-slot frequency hopping; and
performing, by the processor, an uplink (UL) transmission in a subband-fullduplex (SBFD) network with either the intra-slot frequency hopping or the inter-slot frequency hopping enabled.

14. The method of claim 13, wherein, responsive to the intra-slot frequency hopping being enabled for SBFD, the starting RB in each hop is determined as follows:
$${RB}_{start} = \{ \begin{matrix}{RB}_{start} & i = 0 \\ ( {RB}_{start} + {RB}_{offset} ) mod {N}_{RB}^{size} ( j ) + {RB}_{first} ( j ) & i = 1\end{matrix}$$
wherein:
RBₛₜₐᵣₜ denotes the starting RB within a slot based on a frequency-domain resource allocation (FDRA),
RB_{offset} denotes a frequency hopping offset,
i=0 and i=1 denote a first hop and a second hop, respectively,
$${N}_{RB}^{size} ( j )$$
denotes a maximum number of RBs for the set of slots with index j, and
RB_{first}(j) denotes a first UL RB for the set of slots with index j, j∈{0,1}.

15. The method of claim 14, wherein an indication of the set of slots is provided to the UE via a higher-layer parameter, a layer-1 signaling or a bitmap.

16. The method of claim 13, wherein, responsive to the inter-slot frequency hopping being enabled for SBFD, the starting RB in each slot is determined as follows:
$${RB}_{start} ( n ) = \{ \begin{matrix}{RB}_{start} & n mod 2 = 0 \\ ( {RB}_{start} + {RB}_{offset} ) mod {N}_{RB}^{size} ( j ) + {RB}_{first} ( j ) & n mod 2 = 1\end{matrix}$$
wherein:
n denotes a current slot number within a system radio frame,
RBₛₜₐᵣₜ denotes the starting RB within a slot based on a frequency-domain resource allocation (FDRA),
RB_{offset} denotes a frequency hopping offset,
$${N}_{RB}^{size} ( j )$$
denotes a maximum number of RBs for the set of slots with index j, and
RB_{first}(j) denotes a first UL RB for the set of slots with index j, j∈{0,1}.

17. The method of claim 16, wherein an indication of the set of slots is provided to the UE via a higher-layer parameter, a layer-1 signaling or a bitmap.

18. The method of claim 13, further comprising:
applying a first frequency-domain resource allocation (FDRA) of two FDRAs responsive to each slot of the set of slots being a UL-only slot; or
applying a second FDRA of the two FDRAs responsive to each slot of the set of slots being an SBFD partitioned slot,
wherein the starting RB in each slot is determined as follows:
$${RB}_{start} ( n ) = \{ \begin{matrix}{RB}_{start} ( j ) & n mod 2 = 0 \\ ( {RB}_{start} ( j ) + {RB}_{offset} ) mod {N}_{RB}^{size} ( j ) + {RB}_{first} ( j ) & n mod 2 = 1\end{matrix}$$
wherein:
n denotes a current slot number within a system radio frame,
RBₛₜₐᵣₜ(j) denotes the starting RB based on an FDRA for the set of slots with index j,
RB_{offset} denotes a frequency offset,
$${N}_{RB}^{size} ( j )$$
denotes a maximum number of RBs for the set of slots with index j, and
RB_{first}(j) denotes a first UL RB for the set of slots with index j. j∈{0,1}.

19. The method of claim 18, wherein an indication of the set of slots is provided to the UE via a higher-layer parameter, a layer-1 signaling or a bitmap.

20. A method, comprising:
applying, by a processor of a user equipment (UE), a frequency-domain resource allocation (FDRA) Type 0 in a subband-fullduplex (SBFD) partitioned slot;
allocating, by the processor, one or more non-overlapping resource blocks (RBs) within an uplink (UL) resource block group (RBG) responsive to the UL RBG overlapping with a downlink (DL) RBG within the SBFD partitioned slot; and
performing, by the processor, an UL transmission using the allocated one or more non-overlapping RBs,
wherein an UL subband in the SBFD partitioned slot is configured as an integer multiple of a RBG size from a perspective of common resource block (CRB) numbering.
